(19) United States
(12) Patent Application Publication
(10) Pub. No.: US 2016/0155349 A1
(43) Pub. Date: Jun. 2, 2016

(54) CLOUD-BASED VOCABULARY LEARNING SYSTEM AND METHOD

(71) Applicants: Inventec (Pudong) Technology Corporation, Shanghai (CN); INVENTEC CORPORATION, TAIPEI CITY (TW)

(72) Inventor: She-Che JIAN, TAIPEI CITY (TW)

(21) Appl. No.: 14/685,595

(22) Filed: Apr. 14, 2015

(30) Foreign Application Priority Data
Nov. 27, 2014 (CN) 201410707214.2

(51) Int. Cl. G09B 19/00; G09B 7/00

(52) U.S. Cl. CPC G09B 19/00; G09B 7/00

(57) ABSTRACT

A cloud-based vocabulary learning system includes a cloud database and a learning server. The cloud database stores multiple vocabulary sets associated with different levels, and is connected with the learning server. The learning server includes a processor and a memory. The processor executes instructions stored on the memory to receive a user level from a client device. One of the vocabulary sets is selected as, a user vocabulary set according to the user level, and an electronic document is compared with the user vocabulary set to extract new words in the electronic document. The new words are provided to the client device for learning, and are added to the user vocabulary set after learning.

### RELATED APPLICATIONS

This application claims priority to Chinese Application Serial Number 201410707214.2, filed Nov. 27, 2014, which is herein incorporated by reference.

### BACKGROUND

1. Field of Invention

The present disclosure relates to a vocabulary learning system and method. More particularly, the present disclosure relates to a cloud-based vocabulary learning system and method.

2. Description of Related Art

As progress in technology brings the world closer together, international trades and cultural exchanges become more and more frequent. As such, language skill has become one of the most important employability, while vocabulary power is an integral part of the language skill.

A variety of vocabulary building tools are developed to meet the demand of language learners who aim to increase vocabulary power, such as portable electronic dictionary and online dictionary accessible from the Internet. When the language learners encounter new words, they can look up definitions of the new words with these tools. Moreover, the user is allowed to install flashcard-based software and mobile applications displaying a set of virtual cards with words and relevant information of the words from TOEFL or GMAT vocabulary list to aid memorization.

However, current vocabulary learning solutions, such as the aforementioned electronic dictionaries and online dictionaries, still require users to individually enter new words to look up the meaning of each word. Moreover, flashcard based vocabulary memorization tools have the deficiency of ignoring the consideration of context information in learning the new words, which often leads the users unable to apply the words in daily life. Therefore, the current vocabulary learning solutions need to be improved.

### SUMMARY

An aspect of the present disclosure is directed to a cloud-based vocabulary learning system including a cloud database and a learning server. The cloud database is configured for storing multiple vocabulary sets associated with multiple levels, and the learning server is connected with the cloud database. The learning server includes a processor and a memory, and the processor is configured for executing instructions stored on the memory to obtain a user level from a client device, select one of the vocabulary sets to establish a user vocabulary set according to the user level, compare an electronic document with the user vocabulary set to extract new words from the electronic document, and provide the new words and relevant information to the client device for display and learning.

Another aspect of the present disclosure is directed to a cloud-based vocabulary learning method including the following operations: obtaining a user level from a client device and selecting one of vocabulary sets to establish a user vocabulary set according to the user level; comparing an electronic document with the user vocabulary set to extract one or more new words from the electronic document; and providing the new words and relevant information to the client device for display and learning. The vocabulary sets are associated with multiple levels and stored in a cloud database.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a cloud-based vocabulary learning system according to a first embodiment of the present disclosure;

FIG. 2A is a sample screenshot of new words displayed in a list according to an embodiment of the present disclosure;

FIG. 2B is a sample screenshot of new word display according to another embodiment of the present disclosure; and

FIG. 3 is a flow chart of a cloud-based vocabulary learning method according to a second embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

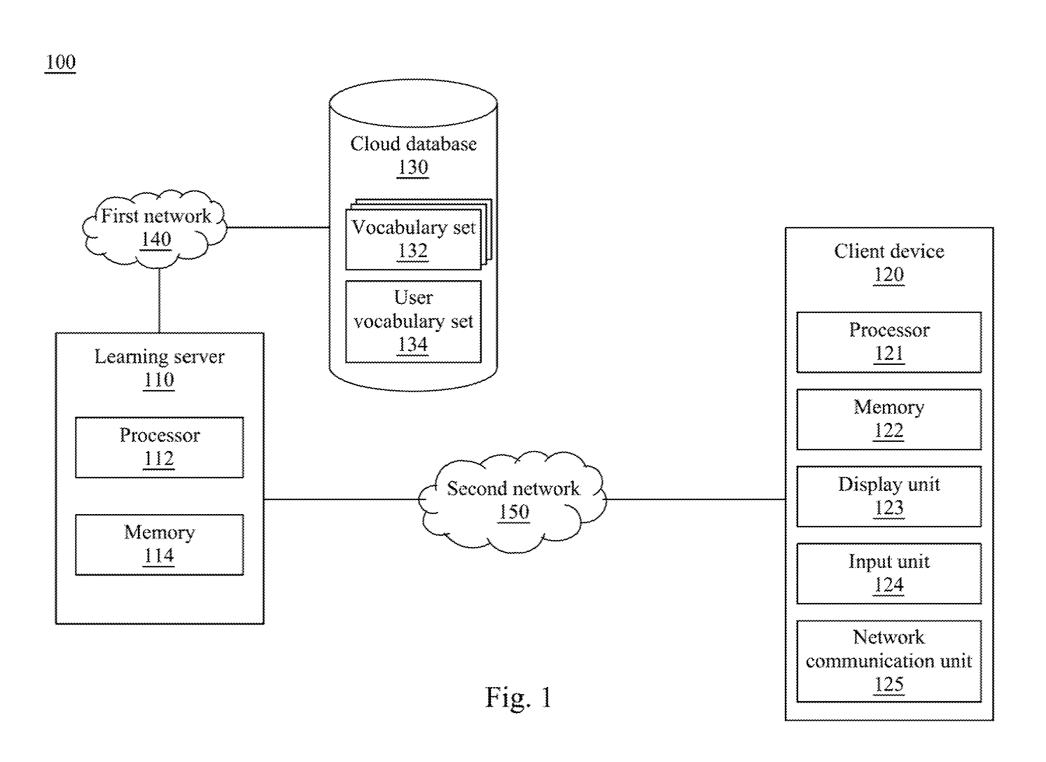

FIG. 1 is a schematic diagram of a cloud-based vocabulary learning system according to a first embodiment of the present disclosure. The cloud-based vocabulary learning system 100 is configured for aiding users to learn new words in an electronic document in a language to be learned. Functions of the cloud-based vocabulary learning system 100 include automatically extracting new words for the user from the electronic document according to the recorded words learned by the user, displaying relevant information of the new words for the user to browse, and adding the new words to the record of the words learned by the user after the user finishes learning. The details of and interoperation between each component of the cloud-based vocabulary learning system 100 are given below.

The cloud-based vocabulary learning system 100 includes a learning server 110 and a cloud database 130. The learning sever 110 is connected to the cloud database 130 via the first network 140 to access the content of the cloud database 130. The user who intends to learn a language operates a client device 120 connected to the learning server 110 via a second network 150.

The learning server 110 includes a processor 112 and a memory 114. In one embodiment, the learning server 110 is a server, the processor 112 is a central processing unit, and the memory 114 includes a random access memory and a hard disk. In another embodiment, the learning server 110 is a workstation, the processor 112 is a central processing unit, and the memory 114 includes a random access memory, a hard disk, and a solid-state drive.

The client device 120 includes a processor 121, a memory 122, a display unit 123, an input unit 124, and a network communication unit 125. In one embodiment, the client device 120 is a tablet or a smart phone, the processor 121 is an ARM architecture processor or a MIPS architecture processor, the memory 122 includes a random access memory, a flash memory and a SD memory card, the display unit 123 is a touch panel or an AMOLED display, the input unit is an optical cursor or a keyboard, and the network communication unit 125 is a mobile communication chipset or WiFi communication chipset. In another embodiment, the client device 120 is a personal computer, the processor 121 is a central processing unit, the memory 122 includes a random access memory and a hard disk, the display unit 123 is an LCD display, the input unit 124 is a mouse and keyboard set, and the network communication unit 125 is a network interface card.

The cloud database 130 is configured for storing multiple vocabulary sets 132 associated with different levels and a user vocabulary set 134. The difficulties of the vocabulary sets 132 increase as the levels upgrade. The number of the vocabulary sets 132 in FIG. 1 is one, but the disclosure is not limited thereto. The user vocabulary set 134 is configured for recording the words that the user has learned. Moreover, the vocabulary sets 132 and the user vocabulary set 134 in the present disclosure can be sets of multiple words or database files, such as SQL database files.

In one embodiment, the vocabulary sets 132 are respectively associated with elementary school level, middle school level, high school level, and college level, etc. In another embodiment, the vocabulary sets 132 are associated with elementary, intermediate, high-intermediate level of General English Proficiency Test (GEPT). It is worth noting that any of the vocabulary sets 132 associated with a certain level includes the words in those vocabulary sets 132 associated with the levels lower than the certain level. In one embodiment, the vocabulary sets associated with different levels are implemented with different database files, and therefore the database file of the vocabulary set 132 associated with a high level is configured to include the words not included in the vocabulary sets 132 associated with the levels lower than the high level to save the storage space. In another embodiment, the level associated with each word data entry included in the database files in the cloud database 130 is recorded, and the vocabulary set 132 associated with a certain level includes all word data entries associated with the levels lower than the certain level. Those skilled in the art can make modifications and variations to implementing the vocabulary sets 132 with the teachings in the present disclosure, and therefore the present disclosure is not limited hereto.

The cloud database 130 is a database accessible from a network and can be implemented with multiple storage devices or a single storage device. The storage device is a hard disk, read-only memory, flash memory, or any other non-transitory computer-readable storage medium. The aforesaid database in the present disclosure is named according to the data stored in itself for clarity and ease of understanding, and the number or content of the database in the present disclosure is not limited hereto.

The memory 114 of the learning server 110 is configured to store one or more instructions, and the processor 112 is configured for executing the instructions stored on the memory 114 to perform the following actions including obtaining a user level from the client device and selecting one of the vocabulary sets 132 stored in the cloud database 130 to establish the user vocabulary set 134 according to the user level.

In one embodiment, the levels of the vocabulary sets 132 include elementary school level, middle school level, high school level, and college level, and the user level is high school level. Therefore, the vocabulary set 132 associated with high school level is selected to establish the user vocabulary set 134. Illustratively, when the user vocabulary set 134 is implemented with a database file, the processor 112 is configured to add the word data entries in the vocabulary set 132 associated with high school level to the database file of the user vocabulary set 134 or record the vocabulary set 132 associated with the user level in the database file of the user vocabulary set 134. Alternatively, an extra field is created for each of the word data entries associated with the levels lower than high school level to tag that the word data entries are included in the user vocabulary set 134. One skilled in the art can make modifications and variations to the implementation of selecting one of the vocabulary sets 132 stored in the cloud database 130 to establish the user vocabulary set 134 according to the user level without departing from the spirit and scope of the present disclosure.

In one embodiment, the client device 120 is configured for sending a user setting message to the learning server 110, and the user setting message includes the user level. Illustratively, the user inputs the user level according to his/her educational background. In another embodiment, the learning server 110 is configured for providing a comparison chart of the levels and scores of language proficiency tests (e.g., TOEIC, TOEFL, IELTS, TELC, and other official standardized test) for reference, and the user determines the user level according to the comparison chart and his/her score in the language proficiency tests to send the user setting message to the learning server 110 to set the user level. In yet another embodiment, the learning server 110 is configured for providing one or more online tests, the user takes the test with the client device 120, and the user level is determined according to a result of the test.

It is worth noting that the user of the cloud-based vocabulary learning system 100 adds multiple words to the user vocabulary set 134 in an efficient way by setting the user level at initialization. The operation of setting the user level can be omitted afterwards, and new words learned after reading an electronic document are added incrementally as detailed in the following descriptions. Moreover, when the user has not used the cloud-based vocabulary learning system 100 for a long time or has joined other language learning courses, the user level is lowered or improved respectively and the operation of setting the user level is performed again.

The actions performed by the processor 112 of the learning server 110 executing the instructions include obtaining an electronic document from the client device 120. In one embodiment, the learning server 110 is configured for providing a user interface for the user to operate the client device 120 to upload document files (e.g., Word files, PDF files, or text files) or webpage files such as HTML files and extracting words in the files as the electronic document. In another embodiment, the learning server 110 is configured for providing a user interface for the user to operate the client device 120 to input a web link, and the learning server 110 is configured to obtain the files from the web link and extract words from the files as the electronic document. In yet another embodiment, the learning server 110 is configured for providing a web form for the user to enter content of the electronic document. One skilled in the art can make modifications and variations to implementation of obtaining the electronic document without departing from the spirit and scope of the present disclosure, and the present disclosure is not limited hereto.

The actions performed by the processor 112 of the learning server 110 executing the instructions include comparing the electronic document with the user vocabulary set 134 to extract one or more new words from the electronic document. In one embodiment, the learning server 110 is configured for extracting all words in the electronic document and comparing the words in the electronic document with the words in the user vocabulary set 134, and the words in the electronic document but not found in the user vocabulary set 134 are the new words. Illustratively, the learning server 110 is configured to compare the words in the electronic document against the words in the user vocabulary set 134 and all their forms (e.g., regular verb tense modification and regular noun plural and singular form), the words in the electronic document which are not matched to the words and their forms included in the user vocabulary set 134 are the new words for the user.

After the learning server 110 is configured for extracting the new words from the electronic document, the operation of providing the new words and relevant information to the client device 120 for display is performed. In other words, the client device 120 is configured for displaying the new words and the relevant information (e.g., meaning and usage of the new words) for the user to read and learn. As a result, the user does not have to go through the hassle of looking up the new words in the electronic document individually, and thus learning more efficiently.

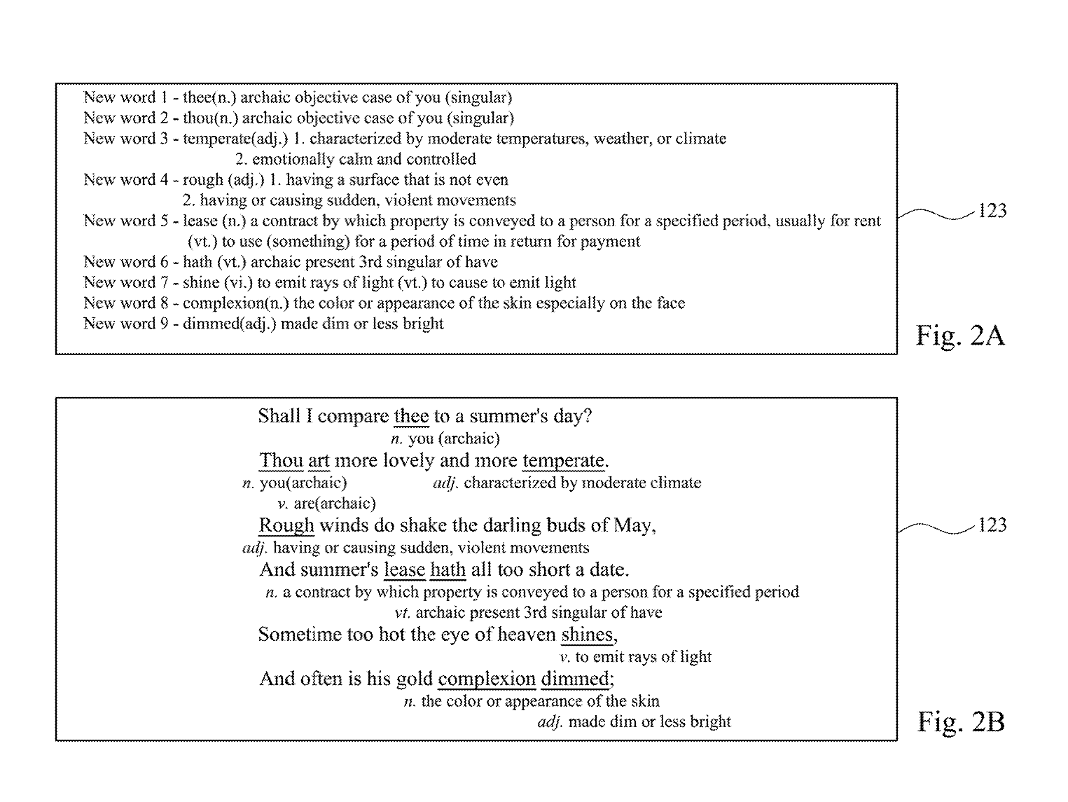

FIG. 2A is an example of a new word list display of a cloud-based vocabulary learning system according to an embodiment of the present disclosure, and shows a screenshot of the new words and the relevant information displayed in a list on the display unit 123 of the client device 120. Accordingly, the user previews the new words before reading the electronic document. The list of new words includes the new words in the electronic document, and the relevant information associated with the new words includes lexical categories (e.g., noun, verb, adjective) and one or more meanings of the new words. In another embodiment, the relevant information further includes pronunciation, sentence examples, synonyms, variation of forms (including the form of a verb for different tenses and the form of a noun for singular or plural), and root words, etc. Other relevant information associated with the new words will be apparent to those skilled in the art, and the disclosure is not limited hereto.

FIG. 2B is an example of a new word display of a cloud-based vocabulary learning system according to another embodiment of the present disclosure, and shows a screenshot of the relevant information displayed at locations associated with the new words in the electronic document on the display unit 123 of the client device 120. As shown in FIG. 2B, the new words in the electronic document are marked with underlines, and the relevant information associated with the new words are displayed under the underlines, so as to provide reference to the user when reading the electronic document. In some implementations, the new words can be marked with a different font size, bold face, italics or color, and not limited hereto. Details of the relevant information associated with the new words are given in the accompanying text of FIG. 2A, and thus not repeated herein. In another embodiment, a user interface is provided for the user to adjust the level of detail and the font size used for displaying the relevant information associated with the new words. For example, the user sets the level of detail such that a single meaning that is most frequently used or most appropriate is displayed without showing the lexical categories and other information, so as to improve the ease of reading and comprehension of the electronic document. In yet another embodiment, the user chooses to hide the relevant information associated with the new words in the display, so as to guess the meaning of the new words in the electronic document with context information before reading and to confirm that he/she has memorized the meaning of the new words without the relevant information being displayed after reading the electronic document.

The user learns the meaning and usage of the new words from the relevant information displayed on the client device 120 and sends a word addition message to the learning server 110 after the new words are learned. The learning server 110 is configured for adding the new words to the user vocabulary set 134 according to the word addition message. Consequently, the cloud database 130 is configured to keep a record of the words that the user has learned and further utilizes the record to automatically extract the words to be learned when the user accesses to the cloud-based vocabulary learning system 100 and upload the electronic document. On the other hand, the user can measure the progress of his/her vocabulary skill with the user vocabulary set 134, which is beneficial for evaluating the learning outcome.

In one embodiment, the user sends the word addition message to add all of the new words to the user vocabulary set 134. In another embodiment, the number of the new words in the electronic document is large, and the user chooses to focus on a part of the new words or learn the new words in multiple batches. Therefore, the user sends the word addition message to add a part of the new words that have been learned.

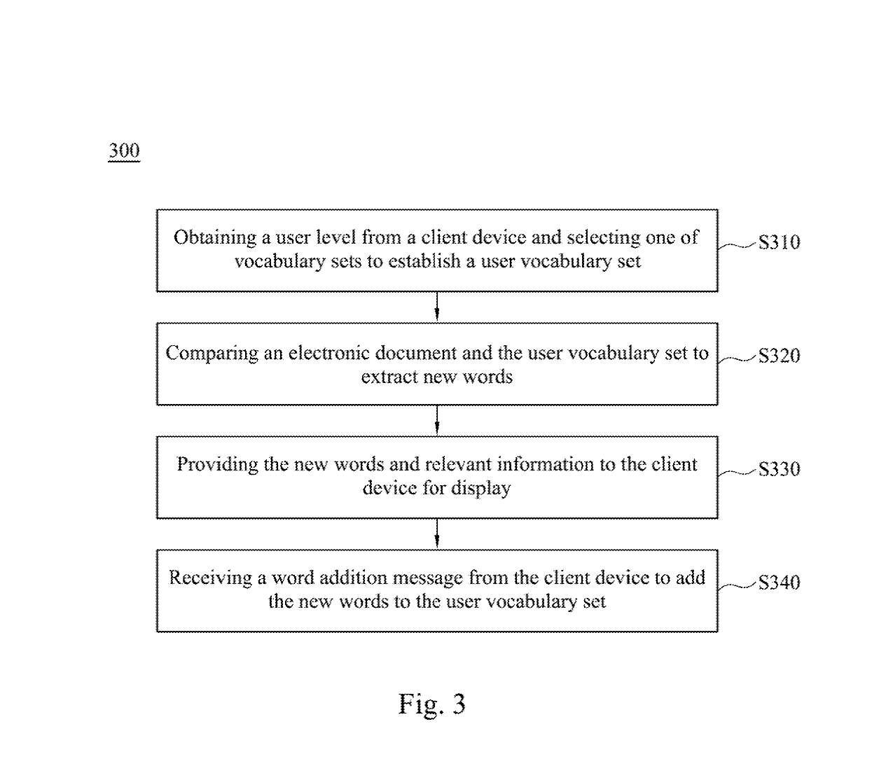

FIG. 3 is a flow chart of a cloud-based vocabulary learning method according to a second embodiment of the disclosure. The cloud-based vocabulary learning method 300 includes multiple operations to record words that a user has learned and extract new words from an electronic document when the user reads the electronic document. For convenience and ease of understanding, the following descriptions for the cloud-based vocabulary learning method 300 takes the cloud-based vocabulary learning system 100 shown in FIG. 1 as an example, but the present disclosure is not limited hereto. While the process flow described below includes a number of operations that appear to be in a specific order, it should be apparent that these operations may include more or fewer operations, which may be executed serially or in parallel (e.g., using parallel processors or in a multi-threading environment).

The learning server 110 is configured for obtaining a user level from the client device 120 and selecting one of vocabulary sets 132 to establish a user vocabulary set 134 according to the user level (S310). The vocabulary sets 132 are stored in the cloud database 130, and the details of the vocabulary sets 132 and the user vocabulary set 134 are given in the accompanying text of FIG. 1, thus not repeated herein. In one embodiment, the learning server 110 is configured for receiving a user setting message including the user level from the client device 120 operated by the user and selecting the vocabulary set 132 to establish the user vocabulary set 134 accordingly. In another embodiment, the learning server 110 is configured for providing one or more online tests for the client device 120. The user operates the client device 120 to take the test, and the learning server 110 is configured for determining the user level according to the result of the tests. The online tests can be obtained from language training institutions.

The user operates the client device 120 to enable the learning server 10 to obtain an electronic document from the client device 120 with the cloud-based vocabulary learning method 300. The electronic document includes an article in the language that the user aims to learn. The details of obtaining the electronic document from the client device 120 are given in the accompanying text of FIG. 1, thus not repeated herein.

To automatically extract new words from the electronic document, the learning server 100 is configured for comparing the electronic document with the user vocabulary set 134 and extracting new words from the electronic document (S320). The new words are the words included in the electronic document but not included in the user vocabulary set 134, and the details of comparing the electronic document with the user vocabulary set 134 to extract the new words are given in the accompanying text in FIG. 1, thus not repeated herein.

The learning server 110 is configured for providing the new words and relevant information associated with the new words to the client device 120 for display (S330). The client device 120 is configured for displaying the new words and the relevant information in different styles suitable for different ways of learning. In one embodiment, the user operates the client device 120 to display the new words and the relevant information on the client device 120 in a list with a user interface provided by the learning server 110. In another embodiment, the user reads the electronic document displayed on the client device 120 and interacts with a user interface provided by the learning server 110 to display the relevant information at locations associated with the new words to aid the comprehension of the electronic document and provide context information for vocabulary learning.

After the user has learned the new words, a word addition message is sent to the learning server 110 from the client device 120. The learning server 110 is configured for adding the new words to the user vocabulary set 134 according to the word addition message (S340). Details of adding the new words to the user vocabulary set 134 are given in the accompanying text in FIG. 1, thus not repeated herein.

The cloud-based vocabulary learning system 100 and the cloud-based vocabulary learning method 300 are described in the present disclosure with single user vocabulary set 134 as an example. One skilled in the art can make modifications and variations to increase the number of the user vocabulary set 134 without departing from the spirit and scope of the present disclosure, and a user account system can be added for the multiple-user scenario.

The cloud-based vocabulary learning system and method described in the present disclosure are utilized to record the words that a user has learned to automatically extract new words in an electronic document to be read by the user. Consequently, the tedious operation of looking up the new words individually is avoided to bring more convenience, and the motivation for learning vocabulary is improved for the user. Moreover, the new words to be learned are from a full article and thus carry context information of the new words. Consequently, the user memorizes the meaning of the new words and further learns how to use the new words. The cloud-based vocabulary learning system and method also display the new words and relevant information associated with the new words in different styles. The user previews all of the new words in the electronic document with the new words displayed in a list before reading the electronic document. While the user reads the electronic document, the relevant information is displayed at locations associated with the new words in the electronic document to aid comprehension and enable the user to learn the new words again with full context. Accordingly, the user understands the meaning of the new words and uses the words learned in speaking and writing. In addition, the user sends a user setting message or takes an online test provided by the cloud-based vocabulary learning system and method to determine a user level indicating his/her size of the vocabulary, so as to add multiple words to the user vocabulary set efficiently. Lastly, the words learned by the user are stored on the cloud database accessible from more than one client device, and thus the user does not need to worry about data loss or synchronization problem and can learn new words everywhere.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cloud-based vocabulary learning system, comprising:
a cloud database configured for storing a plurality of vocabulary sets associated with a plurality of levels; and
a learning server connected with the cloud database and comprising a processor and a memory configured for storing at least one instruction, wherein the instruction is executed by the processor to perform actions comprising:
obtaining a user level from a client device and selecting one of the vocabulary sets to establish a user vocabulary set according to the user level;
comparing an electronic document with the user vocabulary set to extract one or more new words from the electronic document; and
providing the new words and relevant information associated with the new words to the client device for display.

2. The cloud-based vocabulary learning system of claim 1, wherein the actions performed by the processor executing the instruction further comprise:
adding the new words to the user vocabulary set according to a word addition message when receiving the word addition message from the client device.

3. The cloud-based vocabulary learning system of claim 1, wherein the client device is configured for sending a user setting message to the learning server, and the user setting message comprises the user level.

4. The cloud-based vocabulary learning system of claim 1, wherein the learning server is configured for providing one or more online tests to determine the user level.

5. The cloud-based vocabulary learning system of claim 1, wherein the client device is configured for displaying the new words and the relevant information in a list or displaying the relevant information at locations associated with the new words in the electronic document.

6. A cloud-based vocabulary learning method, comprising:
obtaining a user level from a client device and selecting one of a plurality of vocabulary sets to establish a user vocabulary set according to the user level, wherein the vocabulary sets are associated with a plurality of levels and stored in a cloud database;
comparing an electronic document with the user vocabulary set to extract one or more new words from the electronic document; and
providing the new words and relevant information associated with the new words to the client device for display.

7. The cloud-based vocabulary learning method as claimed in claim 6, further comprising:
adding the new words to the user vocabulary set according to a word addition message when receiving the word addition message from the client device.

8. The cloud-based vocabulary learning method as claimed in claim 6, wherein operation of obtaining the user level from the client device comprises:
receiving a user setting message comprising the user level.

9. The cloud-based vocabulary learning method as claimed in claim 6, wherein operation of obtaining the user level from the client device comprises:
providing one or more online tests to determine the user level.

10. The cloud-based vocabulary learning method as claimed in claim 6, wherein the new words and the relevant information are displayed on the client device in a list, or the relevant information are displayed at locations associated with the new words in the electronic document.
